(19) United States
(12) Patent Application Publication
(10) Pub. No.: US 2026/0028732 A1
(43) Pub. Date: Jan. 29, 2026

(54) CONDUCTIVE NETWORK IMPREGNATED WITH HYDROPHOBIC POROUS FOAM FOR USE IN ELECTROCHEMICAL SYSTEMS

(71) Applicant: Lawrence Livermore National Security, LLC, Livermore, CA (US)

(72) Inventors: Maxwell Ivan Goldman, Oakland, CA (US); Santiago Tzintzun, Livermore, CA (US); Andrew Allen Wong, Oakland, CA (US); Sarah E. Baker, Dublin, CA (US); Eric Aidan Krall, Walnut Creek, CA (US)

(21) Appl. No.: 18/783,155

(22) Filed: Jul. 24, 2024

(51) Int. Cl. C25B 11/069; C08J 9/04; C25B 11/032; C25B 11/053

(52) U.S. Cl. CPC C25B 11/069; C08J 9/04; C25B 11/032; C25B 11/053; C08J 2371/02

(57) ABSTRACT

An electrode includes a composite including an electrically conductive metal structure having ligaments and a plurality of pores defined by the ligaments, and a porous material present in the plurality of pores in the conductive metal structure. The electrode has through-plane electrical conductivity.

This invention was made with Government support under Contract No. DE-AC52-07NA27344 awarded by the United States Department of Energy. The Government has certain rights in the invention.

### FIELD OF THE INVENTION

The present invention relates to electrochemical systems, and more particularly, this invention relates to a porous conductive network impregnated with hydrophobic porous foam for use in electrochemical systems.

### BACKGROUND

The technology for carbon dioxide (CO₂) electrolysis includes feeding gases into an electrochemical system. The electrode of the system must be conductive, porous, and hydrophobic-allowing the passage of gas but not liquid. A dominate failure mode of the system includes flooding, such that water builds up in the system. Using hydrophobic material, such as polytetrafluoroethylene (PTFE), improves selectivity and durability of electrolyzers. However, a significant drawback of using PTFE is that PTFE is electrically insulating which prohibits the electrode from making a good contact with the power source. Some attempts to overcome this drawback include engineering a front electrical contact for the electrode. This can be fabricated by coating a pre-existing hydrophobic, porous surface in an electrical conductor such as copper to act as a catalyst and conductive layer. However, front electrical contacts have a variety of issues including poor ohmic resistances, high contact resistances, poor sealing, difficulty to scale, etc. Additionally, a front electrical contact is limiting because it only provides in-plane electrical conductivity.

It would be desirable to fabricate an electrode that includes hydrophobic material and is electrically conductive through the electrode in both the in-plane and through-plane direction.

### SUMMARY

According to one inventive aspect, an electrode includes a composite including an electrically conductive metal structure having ligaments and a plurality of pores defined by the ligaments, and a porous material present in the plurality of pores in the conductive metal structure. The electrode has through-plane electrical conductivity.

According to another inventive aspect, a method for forming a permeable electrically conductive electrode includes obtaining an electrically conductive metal structure and infilling the conductive metal structure with a resin. The resin includes a monomer, a porogen, a curing agent, and a solvent. The method further includes curing the resin to form an electrically conductive polymeric composite having the conductive metal structure impregnated with the cured resin and drying the electrically conductive polymeric composite to form the permeable electrically conductive electrode.

According to yet another inventive aspect, a curable composition includes a monomer, a porogen, and a solvent, wherein the monomer is solvated in the solvent.

Other aspects and advantages of the present invention will become apparent from the following detailed description, which, when taken in conjunction with the drawings, illustrate by way of example the principles of the invention.

### BRIEF DESCRIPTION OF THE DRAWINGS

FIG. 1 is a schematic drawing of electrochemical cells, according to various inventive aspects. Part (a) depicts a double electrolyte gap electrochemical cells, part (b) depicts a single electrolyte gap electrochemical cell, and part (c) depicts a zero gap electrochemical cell. Part (d) is a magnified view of an electrode that may be used in the electrochemical cells, according to one inventive aspect.

FIG. 2 is a schematic drawing of an electrode having a conductive metal structure impregnated with a porous hydrophobic resin plus a coating with a given catalyst layer, resulting in a hydrophobic, electrically conducting, gas permeable composite support structure for a catalyst layer, according to one inventive aspect.

FIG. 3 is a flow chart of a method of forming an electrode having a conductive metal structure impregnated with a hydrophobic resin, according to one inventive aspect.

FIG. 4 illustrates an example of forming a composite having a conductive metal structure impregnated with a hydrophobic resin, according to one inventive aspect. Part (a) depicts the conductive metal structure, and part (b) depicts the saturation of the conductive metal structure with hydrophobic resin.

FIG. 5 depicts scanning electron microscopy images of hydrophobic materials. Part (a) depicts 30 wt. % hydrophobic material, part (b) depicts 35 wt. % hydrophobic material, and part (c) depicts 40 wt. % hydrophobic material.

FIG. 6 illustrates the relative permeability of different hydrophobic materials, according to one inventive aspect.

FIG. 7 illustrates control of the permeability of the hydrophobic material using monomer loadings (part (a)) and curing light intensity (part (b)), according to one inventive aspect.

FIG. 8 depicts a plot of force versus displacement of different hydrophobic materials, according to one inventive concept.

FIG. 9 illustrates the relative contact angle of hydrophobic materials, according to one inventive concept.

FIG. 10 illustrates the relative intra-material pores size of different hydrophobic materials, according to one inventive aspect. Part (a) depicts expanded PTFE (E-PTFE), part (b) depicts 35 wt. % PFPE, and part (c) depicts Sigracet.

FIG. 11 depicts products formed in a single gap electrochemical cells having selected electrodes that include different hydrophobic material, according to one inventive aspect. Part (a) depict products formed with a current density of 100 mA/cm², and part (b) depicts products formed with a current density of 200 mA/cm².

FIG. 12 depicts plots of selectivity of C₂+ products at different current densities, according to one inventive aspect. Part (a) depicts the faradaic efficiency of C₂H₄ products in different electrolyzers, and part (b) depicts the selectivity of C₂+ products in different electrolyzers.

FIG. 13 illustrates the conductive metal structure impregnated with hydrophobic resin, according to one inventive aspect. Part (a) in an image of the conductive metal structure before (left) and after (right) hot-pressing the structure. Parts (b) and (c) depict scanning electron microscopy images of the surface of the conductive metal structure impregnated with hydrophobic material. Part (d) is an image of a conductive metal structure impregnated with 35 wt. % PFPE having a catalyst coating.

FIG. 14 illustrates the through-plane conductivity of the electrode having a conductive metal structure impregnated with hydrophobic material, according to one inventive aspect. Part (a) depicts the faradaic efficiency of a front contact, and part (b) depicts the faradaic efficiency of a back contact.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

For the purposes of this application, room temperature is defined as in a range of about 20° C. to about 25° C.

As also used herein, the term “about” denotes an interval of accuracy that ensures the technical effect of the feature in question. In various approaches, the term “about” when combined with a value, refers to plus and minus 10% of the reference value. For example, a thickness of about 10 nm refers to a thickness of 10 nm±1 nm, a temperature of about 50° C. refers to a temperature of 50° C.±5° C., etc.

A “nano” dimension or descriptor such as nanoscale, nanoporous, etc. is defined as having a diameter or length (e.g., a pore having an average diameter) less than 1000 nanometers (nm). A “micro” dimension or descriptor such as microscale, microporous, micron-sized, etc. is defined as having a diameter or length (e.g., a pore having an average diameter) less than about 1000 microns (μm).

It is also noted that, as used in the specification and the appended claims, wt. % is defined as the percentage of weight of a particular component relative to the total weight/mass of the mixture. Vol. % is defined as the percentage of volume of a particular compound relative to the total volume of the mixture or compound. Mol. % is defined as the percentage of moles of a particular component relative to the total moles of the mixture or compound. Atomic % (at. %) is defined as a percentage of one type of atom relative to the total number of atoms of a compound.

Unless expressly defined otherwise herein, each component listed in a particular approach may be present in an effective amount. An effective amount of a component means that enough of the component is present to result in a discernable change in a target characteristic of the ink, printed structure, and/or final product in which the component is present, and preferably results in a change of the characteristic to within a desired range. One skilled in the art, now armed with the teachings herein, would be able to readily determine an effective amount of a particular component without having to resort to undue experimentation.

The following description discloses several preferred inventive aspects of porous conductive network impregnated with hydrophobic porous foam for use in electrochemical systems and/or related systems and methods.

In one general inventive aspect, an electrode includes a composite including an electrically conductive metal structure having ligaments and a plurality of pores defined by the ligaments, and a porous material present in the plurality of pores in the conductive metal structure. The electrode has through-plane electrical conductivity.

In another general inventive aspect, a method for forming a permeable electrically conductive electrode includes obtaining an electrically conductive metal structure and infilling the conductive metal structure with a resin. The resin includes a monomer, a porogen, a curing agent, and a solvent. The method further includes curing the resin to form an electrically conductive polymeric composite having the conductive metal structure impregnated with the cured resin and drying the electrically conductive polymeric composite to form the permeable electrically conductive electrode.

In yet another general inventive aspect, a curable composition includes a monomer, a porogen, and a solvent, wherein the monomer is solvated in the solvent.

A list of acronyms used in the description is provided below.
3D three-dimensional
CO₂ carbon dioxide
GDE gas diffusion electrode
nm nanometer
NMP N-methylpyrrolidone
PTFE polytetrafluoroethylene
PFPE perfluoropolyether
TEG triethylene glycol
μ m micron
UV ultraviolet
wt. % weight percent

According to one inventive aspect, an effective approach includes an electrode having a conductive structure impregnated with porous hydrophobic material to allow for through-plane electrical conductivity of the material while still allowing for high hydrophobicity. The electrode also may be engineered for high catalyst activity. The electrode may also be engineered for high in-plane electrical conductivity. An electrode having through-plane conductivity includes fabrication of a “back contact” to the gas diffusion electrode (GDE), thereby significantly reducing cell voltage and lengthening cell-lifetime by improving charge uniformity across the electrochemical cell.

Conventional hydrophobic polytetrafluoroethylene (PTFE)-based electrodes do not demonstrate through-plane conductivity where electrical contact occurs through a plane of the electrode, such that conductivity on the front side of the plane allows current to pass through the plane to the back side of the plane in a direction that is orthogonal to the plane. In contrast, in-plane conductivity does not pass through the plane in a direction perpendicular to the plane. A coating of conductive material on a surface of a material that is not conductive is limited to in-plane conductivity along the surface of the conductive material. A front contact allows collection of current along the plane of the front-side of the electrode, i.e., the side facing the membrane of the electrochemical cell.

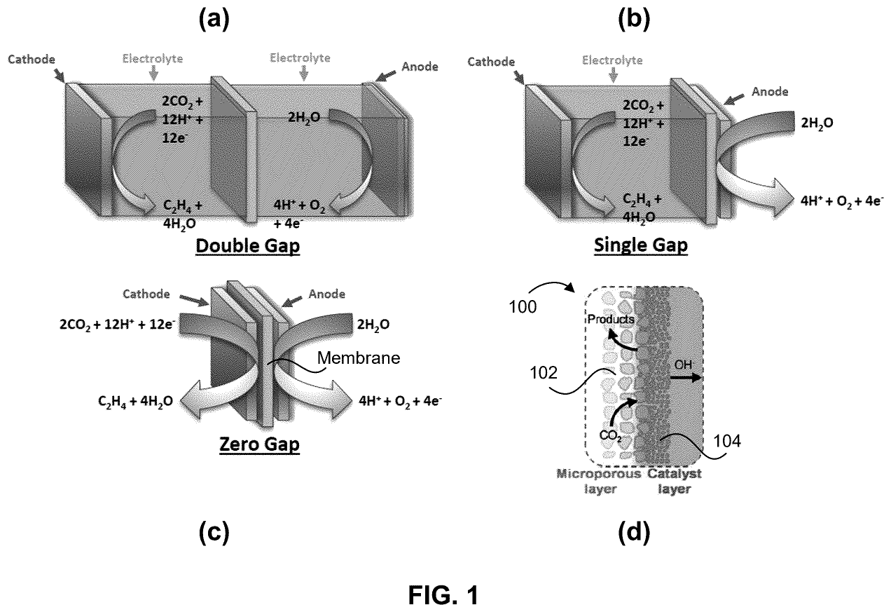

As illustrated in the schematic diagrams of FIG. 1, there are multiple configurations for various different electrochemical cells. A double gap and single gap electrochemical cell as illustrated in parts (a) and (b) include a reservoir (or “gap”) for electrolyte. Recent studies demonstrate that minimizing the gap between the electrodes (i.e., anode and/or cathode) and the membrane, to a zero gap as illustrated in part (c), increases efficiency of the electrochemical cell by removal of a conductive electrolyte, thereby reducing ohmic resistances. A zero gap electrochemical cell has the cathode and anode positioned adjacent to the membrane. In a preferred system, an electrode 100 as illustrated in part (d) has a microporous layer 102 and a catalyst layer 104 to support electrochemical reactions at the conjunction of a solid, liquid, and gaseous interface. Notably, the GDL includes an electrically conducting catalyst that supports the electrochemical reaction between the liquid and gaseous phase.

There is a need for combinations of these layers, including the electrically conducting catalysts layer and microporous layer, to be tunable such that the electrical conductivity and catalytic activity of the catalyst layer remains high, and the microporous layer has sufficient pore geometry and chemical hydrophobicity to remain permeable to gases and water vapor, but also remain impermeable to liquid (e.g., water). These tunable properties are particularly important for zero gap electrochemical cell architectures where the transport of electrolytes flowing across the catalyst surface cannot be maintained in the same way as the double gap or single gap electrochemical cell architectures.

In various approaches, a porous polymeric material may be fabricated and tuned to create an efficient electrode in an electrochemical system. In a preferred approach, the porous polymeric material may be a porous hydrophobic polymeric material. Moreover, copper may be capable of providing mechanical stability and through-plane conductivity that cannot occur in conventional PTFE-based electrodes. In initial approaches, a copper backing layer was included with hydrophobic material to provide good mechanical stability; and it was surprising that the combination of the porous copper support infilled with PFPE with an added layer of copper catalyst also demonstrated through-plane conductivity.

According to one inventive aspect, a composite electrode having a metal structure infilled with a resin of hydrophobic material provides through-plane conductivity and increases the scalability of the electrochemical cell. Moreover, there is no longer a need for a front contact thereby alleviating problems with contact-losses and sealing of the electrolyzer. This is in sharp contrast to the current state of the art that relies on mechanical deformation of expanded PTFE (E-PTFE) that must be mechanically pulled apart to create pores for electrodes and requires a front contact.

In some conventional electrodes, a backing layer added to a composite of hydrophobic material may provide mechanical stability. In one approach, the backing layer may be comprised of polyester, polypropylene, etc. A further consideration includes using a backing layer like a metal foam. For example, copper may be used as a backing material, and because copper is typically included as a catalyst, the presence of copper may reduce contamination in the system. However, in these systems, a non-conductive backing layer added to a porous material still requires a front electrical contact in order to maintain electrical conductivity through the in-plane direction of the electrode.

In various approaches, a conductive structure, e.g., metal foam, porous scaffold, porous framework, porous network, etc. impregnated with porous resin may also provide much needed mechanical support for the porous resin, preventing further collapsing of the pores once used in an electrochemical cell. In preferred approaches, the porous resin is a porous hydrophobic resin. Additionally, because the entire structure is conductive, the final product contains through-plane conductivity and can therefore utilize a “back contact” method of current conduction instead of using a front electrical contact method. This significantly reduces the cell electrical resistance and operating voltage, and offers higher charge uniformity increasing the lifespan and scale-up ability of the technology.

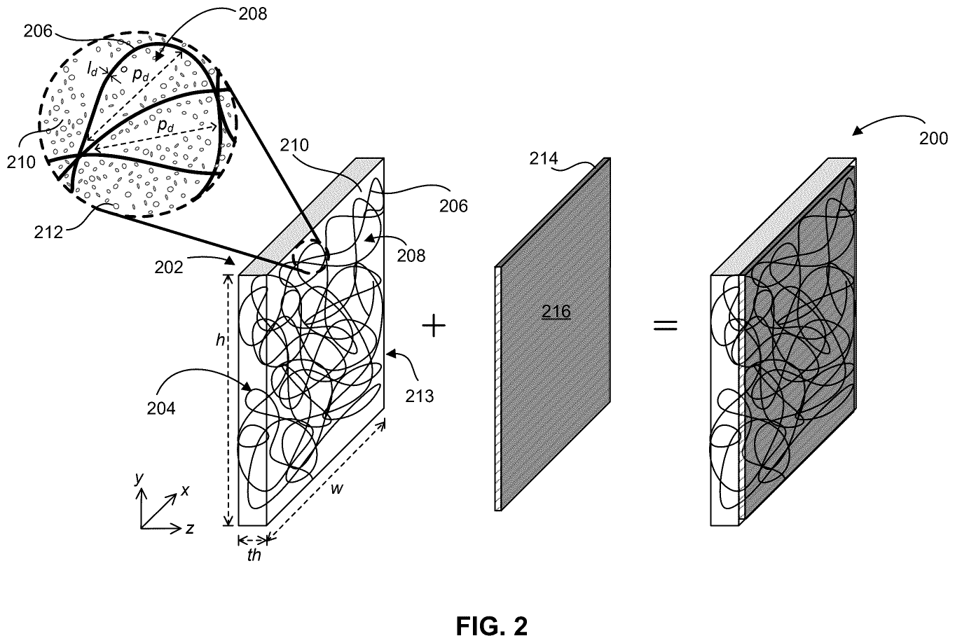

FIG. 2 illustrates examples of an electrode 200, in accordance with one aspect of an inventive concept. As an option, the present electrode 200 may be implemented in conjunction with features from any other inventive concept listed herein, such as those described with reference to the other FIGS. Of course, however, such an electrode 200 and others presented herein may be used in various applications and/or in permutations which may or may not be specifically described in the illustrative inventive aspects listed herein. Further, the electrode 200 presented herein may be used in any desired environment.

According to one inventive aspect, an electrode includes a composite comprised of an electrically conductive metal structure and ligaments and a plurality of pores defined by the ligaments. As illustrated in FIG. 2, an electrode 200 includes a composite 202 that has an electrically conductive metal structure 204. The conductive metal structure 204 has ligaments 206 and a plurality of pores 208 defined by the ligaments 206. The ligaments may be an ordered array of ligaments having a predefined geometric pattern. The ligaments may be a random array of ligaments that define a plurality of pores. The conductive metal structure may be characterized as a conductive metal foam, a conductive scaffold, a conductive network, a permeable metal solid, etc. The outer dimensions (height h, width w, and thickness th) of the composite 202 are about equal to the dimensions of the electrode 200. In one approach, the outer dimensions h, w, th, of the conductive metal structure 204 may be about equal to the outer dimensions of the composite 202.

A preferred thickness th of the conductive metal structure 204 is in a range of about 50 μm to about 500 μm. The thickness th of the conductive metal structure is defined by the application of the electrode. The thickness th of the conductive metal structure 204 is about equal to the thickness of the composite 202.

As illustrated in the magnified view of a portion of the composite 202, in various approaches, the conductive metal structure 204 includes ligaments 206 having an average diameter 1a in a range of greater than 0 μm to less than 50 μm. The average diameter 1a of the ligaments may be defined as the average maximum diameter (i.e., thickness) of a series of ligaments that form the conductive metal structure. The ligaments may be one or more continuous ligament that are shaped to form a random or ordered plurality of pores within the shaped structure. In some approaches, an average diameter of the ligaments may be larger than 50 μm. The average diameter of the ligaments is defined by the process of forming the ligaments.

In various approaches, the ligaments 206 define a plurality of pores 208 having an average maximum diameter pa in a range of greater than 0 μm to less than 1000 μm, and may be smaller or larger. In a preferred approach, an average maximum diameter pa of the pores 208 is in a range of greater than 100 μm to less than 800 μm. In another approach, an average maximum diameter pa of the pores 208 is in a range of greater than 200 μm to less than 600 μm.

The composite comprises a porous material present in the plurality of pores in the conductive metal structure. In preferred approaches, the composite includes a porous hydrophobic material present in the plurality of pores in the conductive metal structure. In one example, as illustrated in the example of FIG. 2, a composite 202 includes a porous hydrophobic material 210 present in the plurality of pores 208 defined by the ligaments 206 of the conductive metal structure 204. The porous hydrophobic material preferably has a plurality of intra-material pores 212. The plurality of intra-material pores 212 are distributed randomly throughout the hydrophobic material 210. In various approaches, the intra-material pores are nanopores having an average maximum diameter in a range of 100 nm to 1000 nm. In some approaches, the intra-material nanopores have an average maximum diameter in a range of 100 nm to 500 nm. In some approaches, the intra-material pores may be micropores, having an average maximum diameter in a range of 500 nm to 1000 nm, 1000 nm to 5000 nm, 2000 nm to 10,000 nm, etc.

It is preferable to include hydrophobic material in the electrode to increase the durability of the electrochemical cell (e.g., electrolyzer). Over time, a carbon-based electrode that has a hydrophobic coating will lose some of the hydrophobic coating, and the electrode becomes more hydrophilic over time leading to water build up and flooding. Because electrolyzers make liquid products, such as ethanol, acetate, isopropanol, etc., the hydroscopic properties of these organic compounds pull water onto the surface of the electrode, and build-up of those organic compounds leads to deleterious flooding. Preferably, a higher amount of hydrophobicity in the electrode material is one of the most promising approaches of creating a durable electrolyzer. The presence of water and hydrophilicity shortens the durability of the electrodes to less than 100 hours.

According to one aspect, a composite includes a porous material present in the pores defined by the ligaments of the electrically conductive structure. In some approaches, the porous material is a stable polymeric material that is unreactive with components of the electrochemical cell. In preferred approaches, the porous material is a crosslinkable monomer and/or polymer. In some approaches, the porous material is a curable monomer and/or polymer. In a preferred approach, the porous polymeric material includes a hydrophobic monomers and/or polymers. In one approach, the porous material may be hydrophilic.

In various approaches, the porous material includes a polymerized and crosslinked monomer. The monomer may include one of the following monomers and/or polymers: perfluoropolyether (PFPE), a siloxane, a polyester, a polypropylene, a poly(lactic-co-glycolic) acid (PLGA), a polyethylene, a polystyrene, a urethane, a thiol-ene, an acrylic, an epoxy, methyl methacrylate, vinyl chloride, low-density polyethylene (LDPE), polyamides, polyimides, nylons, etc. A monomer and/or polymer may be a linear or a branching structure. In some approaches, the porous polymeric material may include a hydrophilic monomer and/or polymer. In preferred approaches, the monomer includes a hydrophobic monomer. In an exemplary approach, the porous material includes a polymerized and crosslinked hydrophobic monomer.

According to one aspect, a stiffness of the hydrophobic material is an important factor to consider when designing a GDE because a GDE should withstand pressure during cell assembly and operation. Moreover, a zero gap cell may also function with higher pressures to operate compared to single or double gap cells. Thus, the composite structures may be suitable for any environment, and any cell architecture. In one example, a hydrophobic material comprised of PFPE at different loadings (30 wt. %, 35 wt. %, and 40 wt. %) demonstrates a stiffness comparable to conventional materials E-PTFE and carbon paper.

In some approaches, the porous material includes a polymerized and crosslinked monomer that is stable. A stable crosslinked monomer does not degrade chemically under operational temperatures or when exposed to electrolytes. Not degrading chemically means that chemical bonds connecting monomers do not break and chemical functional groups on the monomer are not cleaved or removed. Additionally, a stable crosslinked monomer retains both a porous structure and hydrophobic properties during cell assembly and operation. In particular, the porous material does not warp and maintains porosity and does not dissolve or degrade during prolonged use in a selected electrochemical system.

In various approaches, some electrolyzers are more sensitive and prone to water crossover and flooding, and thus, the porous material may be less hydrophobic. For example, fuel cells, water electrolysis, etc. include electrodes that function in an aqueous system. In one approach, an electrode having a less hydrophobic porous material may function in a reactive carbon capture system.

An electrically conductive metal structure (without porous material impregnated in the structure) that only includes metal such as copper, an inert metal, another conductive material, etc. is hydrophilic and microporous, and would lead to flooding, preventing gas diffusion to a catalyst surface. For example, in an electrochemical cell for CO₂ electrolysis, flooding of the electrode with moisture would inhibit CO₂ from accessing the catalyst surface. Moreover, a porous material is not hydrophilic, for example, the porous material is not moisture-wicking. An example of a moisture-wicking material is cotton which would attract water to the electrode. Thus, any monomer and/or polymer that attracts moisture is not preferred for the porous material. In some approaches, the monomer and/or polymer may not be hydrophilic (i.e., not moisture-wicking) and, thus, may be included as a monomer and/or polymer in the porous material. However, a composite that includes an electrically conductive metal structure impregnated with a porous non-hydrophilic material may be sufficiently hydrophobic and microporous for use as an electrically conductive gas diffusion electrode in electrochemical cells.

According to one inventive aspect, an electrode as described herein has through-plane electrical conductivity. The electrically conductive metal structure includes an electrically conductive metal that is not chemically active in the presence of the porous material impregnated in the structure. In a preferred approach, an electrode includes an electrically conductive material that is not chemically active in the presence of a selected hydrophobic material. Preferably, the electrically conductive metal is nonreactive to the hydrophobic material. In a preferred approach, the electrically conductive metal is an inert metal. The metal material, because of the polymer filler, may not be ionically conductive and the metal material may not function as a catalyst. In some electrochemical systems, it is preferable to minimize the formation of byproducts that result from chemical reactions involving the metal material.

However, in some electrochemical systems, including a less inert metal, such as copper, for the porous metal network may be beneficial to the system. In one approach, an electrode includes a metal network and a catalyst comprising the same material. In other words, a metal material may be included to function as a metal structure and as a catalyst layer. For example, an electrode may include a copper metal network and a layer of copper catalyst, where the copper network functions to provide mechanical stability and through-plane conductivity, and the catalyst layer functions as a catalyst for the electrochemical reaction. The function of each copper component is distinct.

Physically separated metal electrodes are not electrically active and cannot pass an electrical charge without completing a circuit (i.e., they have a conductor connecting them which, for electrochemical cells, is an ionically conductive media that passes ionic current between an anode and cathode). In an electrochemical cell, the conductor may be water, an electrolyte, a solvent, a membrane, etc. Thus, in some systems, the outer surface of the metal network having a catalyst layer may be electrically active. However, a metal network impregnated with hydrophobic material preferably does not have ionic conductivity inside the metal network, due to tortuosity of the network and lack of conductive media, so the internal metal material of the metal network will not react chemically or electrochemically with the conductive electrolyte.

Hypothetically, any material that is inert may be used for various applications. Preferably, the conductive metal structure includes an inert metal that is non-reactive with substances. For example, the metal structure may include an inert metal such as palladium, platinum, etc. and then a catalyst may be layered on top of the metal structure. In one example, the metal foam structure may include copper. Preferably, the activity of the metal used in the metal foam structure may determine whether the metal is an appropriate material. For example, increasing activity of the material correlates with diminished use in the electrode. Preferably, the material for the metal structure is an inert metal (e.g., noble metals) do not form compounds with other elements due to the arrangement of electrons in their valence shell). For example, exemplary inert metals include: gold (Au), platinum (Pt), Pt group metals (ruthenium, rhodium, osmium, rhenium, iridium), and also silver (Ag), copper (Cu), magnesium (Mg). Other metals include aluminum, bismuth, tin, palladium, nickel, titanium, scandium, chromium, cobalt, hafnium, boron, tantalum, tungsten, vanadium, etc. In one approach, a metal mesh may be used, such as a titanium mesh (Ti mesh) that is known to be stable in hydrophobic conditions, etc. In one approach, the metal structure may be a pure metal structure. In some approaches, the metal structure may include an alloy.

In an exemplary approach, a copper network allows through-plane conductivity for multiple materials. In studies using materials for mechanical support, copper has not been preferred because copper is easily oxidized and then loses efficiency in electrical conductivity by losing good electrical contact between the oxidized copper wires. However, as described herein, a copper foam infilled with hydrophobic material may be protected from oxidization. The hydrophobic material prohibits water from coalescing on the surface of the copper. Preferably, the composite including the hydrophobic material having permeability, pore structure, mechanical stability, etc. is used as an electrode.

In other approaches, for systems including electrochemical reactions with carbon monoxide, conductive metal structures (e.g., networks, scaffolds, foams, etc.) may preferably include gold, silver, etc. that function as a catalyst as well as a mechanical support.

Preferably, the electrode remains stable with high through-plane conductivity and low overpotential, reducing the applied voltage. A lower cell voltage allows a higher energy efficiency of the electrode. Carbon support electrodes have demonstrated through-plane conductivity where the carbon support electrodes have a layer of PTFE on the front surface of the electrode. However, this lowers the conductivity because the layer of PTFE on the front of the electrode functions also as an insulating layer. In the electrode described herein, bare copper (e.g., metal support) pokes through the porogen, and thus, is an ideal conductor by providing lower cell voltage than a carbon GDE while also providing through-plane conductivity.

Early studies included adding conductive particles, such as conductive nanowires, to a resin. However, the conductive nanoparticles/nanowires do not efficiently connect to each other throughout the resin. Thus, there is no through-plane conductivity because the nanoparticles/nanowires do not provide an interconnected network across the structure. A composite of resin and conductive nanoparticles and/or nanowires is not conductive across the resin product. Moreover, adding a sufficient amount of conductive nanoparticles and/or nanowires to cause the structure to be conductive would be excessive and deleterious to uniform curing of the resin. The over-loaded resin will have less access to applied UV light, thereby inhibiting uniform crosslinking of the resin due to the excessive amount of nanoparticles/nanowires blocking light penetration.

According to one inventive aspect, an electrode includes a layer of a catalyst positioned directly on a surface of the composite. As illustrated in FIG. 2, a catalyst layer 214 may be added to the composite 202 directly onto a surface 213 of a side of the composite 202. In one approach, a layer of catalyst is positioned on an outer surface of the composite. A catalyst layer maintains ionic conductivity from the cathode to the anode thereby causing the electrochemical cell to be electrically active. The catalyst layer 214 includes a catalyst material 216. The catalyst material may include at least one of the following catalyst materials: gold, silver, tin, bismuth, platinum, palladium, iron, nickel, iridium, titanium, molybdenum, indium, scandium, and copper, In some approaches, the catalyst material may include an oxide. For example, the catalyst material may include copper oxide, nickel oxide, etc. In some approaches, the catalyst material may include a mixed alloy. For example, the catalyst material may include copper-silver, copper-gold, etc. In some approaches the catalyst material may include a dilute alloy additive such as ruthenium, chromium, cobalt, hafnium, boron, tantalum, tungsten, vanadium, etc. in majority copper atomic lattice. Material for the catalyst layer may include catalyst materials generally known in the art for electrochemical systems.

According to one inventive aspect the electrode is a gas diffusion electrode. In preferred approaches, a gas diffusion electrode may be characterized as having high permeability, conductivity, and hydrophobicity. In one approach, this may be achieved by coating a pre-existing porous, hydrophobic structure with a conductive layer which also serves as a catalyst. The same effect can be achieved, however, if a pre-existing conductive framework is impregnated with a porous hydrophobic material before coating in catalyst. This allows for through-plane conductivity of the GDE since the support structure is inherently conductive and would reduce cell voltage significantly while also subsequently increasing charge uniformity.

In one approach, an electrode may not include a catalyst layer. The composite electrode may not include a coating of copper on a surface of the electrode. The electrode functions in the electrochemical cell without the catalyst layer.

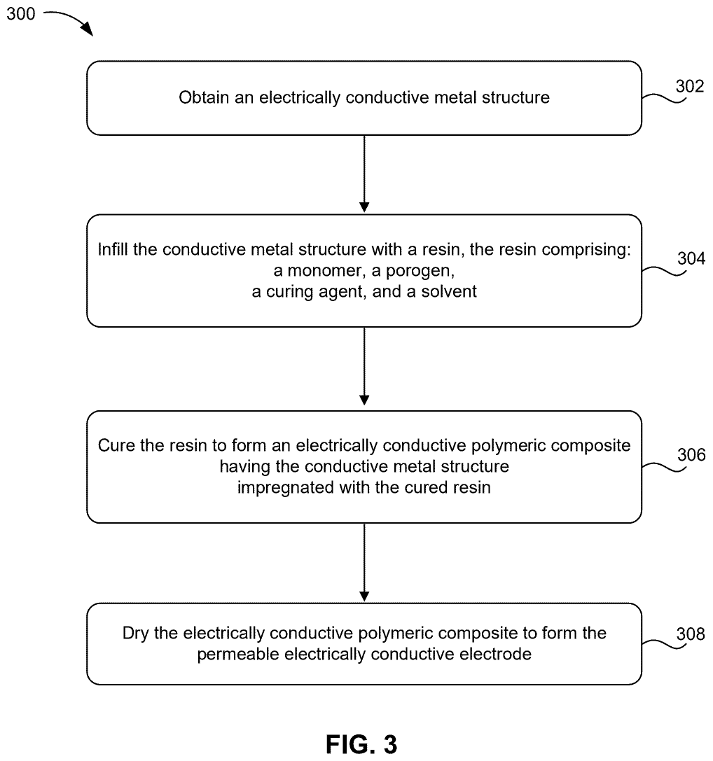

FIG. 3 shows a method 300, in accordance with one aspect of one inventive concept. As an option, the present method 300 may be implemented to construct structures such as those shown in the other FIGS. described herein. Of course, however, this method 300 and others presented herein may be used to form structures for a wide variety of devices and/or purposes which may or may not be related to the illustrative inventive aspects listed herein. Further, the methods presented herein may be carried out in any desired environment. Moreover, more or less operations than those shown in FIG. 3 may be included in method 300, according to various inventive aspects. It should also be noted that any of the aforementioned features may be used in any of the inventive aspects described in accordance with the various methods.

Method 300 may begin with operation 302 that includes obtaining a an electrically conductive metal structure. In some approaches, an electrically conductive metal structure may be obtained commercially. In some approaches, an electrically conductive metal structure may be formed using generally understood methodology of forming metal structures, such as metal foam structures. In a preferred approach, an electrically conductive metal structure may be engineered for increased gas flow using additive manufacturing techniques. In some approaches, an electrically conductive metal structure may be engineered for optimized mass transport, mechanical stability, etc.

In a preferred approach, an electrically conductive metal structure is formed as a mechanical support for an electrode. The conductive metal structure may be formed of a material that provides mechanical support and functions as a catalyst for the electrolysis reaction. In various approaches, the metal structure may be formed with an electrically conductive material. For example, the conductive metal structure may include copper, silver, silver nanowires, gold, etc. In various approaches, a foam backing structure may be formed with a material that is a catalyst for an electrolysis reaction. For example, copper is a catalyst for a CO₂ electrolyzer.

As described herein, the material for the metal structure may be an inert metal that is unreactive with the porous monomer resin. In a preferred approach, the material is unreactive with a hydrophobic monomer resin. In some approaches, the metal material may not be an inert metal. In various approaches, the conductive metal structure includes one of the following metals: copper, platinum, palladium, gold, silver, titanium, magnesium, etc. In a preferred approach, the conductive metal structure includes copper. Preferably, the metal structure includes a metal material that is stable in hydrophobic conditions.

A pre-compressed metal structure may not provide a preferred metal structure for the composite. The metal structure is a structure characterized by an arrangement of ligaments wherein the ligaments define pores within the structure. The metal structure may be a metal foam. In one exemplary approach, the metal structure is formed by compressing a formed metal structure. Preferred characteristics of the metal structure include having a thickness initially of 1.5 mm that is then pressed to a thinner structure having thickness of 200 μm. The extent of compression of the metal structure may be 10× the original thickness. The extent of compression may depend on the original density of the metal structure. A method of pressing the structure includes hot pressing. The pressing allows a structure having a certain mass pressed into a smaller volume, the pores are flattened. In preferred approaches, starting with a thick foam metal structure and pressing to a predefined thickness allows a defined pore structure and metal density and volume ratio with the porogen.

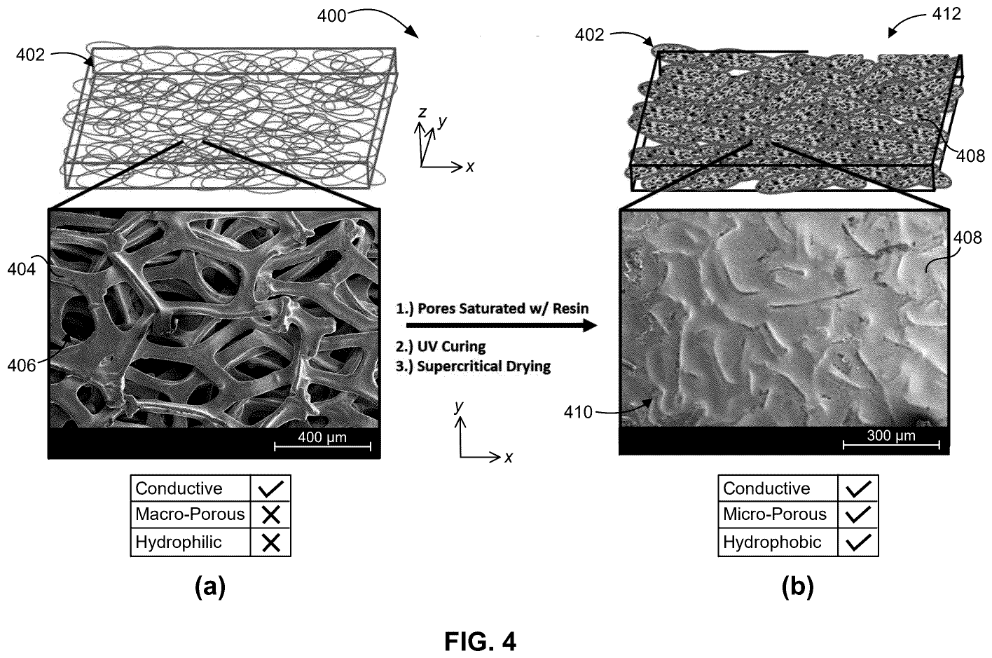

FIG. 4 illustrates an example of a method 400 of forming a composite. Part (a) illustrates a drawing of conductive metal structure 402. A portion of the conductive metal structure 402 is illustrated in the image of part (a). The image depicts ligaments 404 that define pores 406 within the conductive metal structure 402. The conductive metal structure may include layers of ligaments and pores that may be formed by pressing a thicker metal structure into a thin metal structure and compressing the ligaments together. The conductive metal structure 402 is conductive, macroporous, and hydrophilic.

In various approaches, an average diameter of the pores that are defined by the ligaments of the structure may be in a range of 200 μm to 800 μm, as illustrated, for example in the image of part (a) of FIG. 4. In some approaches, pores may have an average maximum diameter in a range of than 100 μm to 1000 μm (1 mm) but may be smaller or larger. In some approaches, pores larger than 1 mm (1000 μm) may cause the resin to shift position, delaminate, crack, etc.

Operation 304 includes infilling the conductive metal structure with a resin. In a preferred approach, the conductive metal structure is infilled with a hydrophobic resin. The process of infilling a conductive metal support for use in electrochemical reduction reactions may be challenging due to difficulty with producing a uniform, porous, hydrophobic foam. The resin preferably includes a monomer, a porogen, a curing agent, and a solvent. In preferred approaches, the resin is a curable composition that includes a hydrophobic monomer, a porogen, and a solvent.

In various approaches, the monomer is capable of being solvated into a liquid with the solvent. In a preferred approach, the resin includes a hydrophobic monomer that is capable of being solvated into a liquid. For example, a hydrophobic monomer may be solvated in the solvent where the hydrophobic monomer molecules are stabilized in solution surrounded or complexed by solvent molecules. The liquid form of the hydrophobic materials allows the hydrophobic material to impregnate, infill, saturate, etc. the mechanical structure. In various approaches, the resin is photocurable. The curable composition is a liquid.

As described herein, preferably the monomer is capable of polymerization and crosslinking. The monomer may include a polymer capable of crosslinking and further polymerization. In some approaches, the monomer includes a hydrophobic polymer that may be further polymerized and/or crosslinked. The monomer and/or polymer may include one of the following monomers and/or polymers: perfluoropolyether (PFPE), a siloxane, a polyester, a polypropylene, a poly(lactic-co-glycolic) acid (PLGA), a polyethylene, a polystyrene, a urethane, a thiol-ene, an acrylic, an epoxy, methyl methacrylate, vinyl chloride, a low density polyethylene (LDPE), a polyamide, polyimide, nylon, etc. In an exemplary approach, the hydrophobic monomer includes perfluoropolyether (PFPE). In some approaches, other non-fluorinated alternative may be a preferred hydrophobic material. Preferably, the monomer and/or polymer is a hydrophobic monomer and/or polymer.

The monomer and/or polymer may be functionalized in a way that it can react with a crosslinker or initiator. The monomer and/or polymer may be capable of being polymerized into a linear or a branching structure. In various approaches, the curable compositions includes a monomer that has at least one functional group for crosslinking. In some approaches, the functional group may include molecular functional groups that participate in crosslinking, such as silane, acrylate, thiol, difunctional acrylate, methacrylate, difunctional methacrylate, diene, vinyl, hydroxyl, carbonyl, carboxyl, amino, sulfhydryl, phosphate, amidogen, etc. In some approaches, the monomer and/or polymer includes at least one functional groups that promote hydrophobicity of the monomer and/or polymer, such as halogen moieties (e.g., fluorine, chlorine, etc.), arene (aromatic rings), ether, methyl, acrylate, difunctional acrylate, methacrylate, difunctional methacrylate, etc. In one approach, the monomer and/or polymer includes a halogen moiety such as fluorine. In an exemplary approach, a monomer and/or polymer has at least one functional group for crosslinking and at least one functional group that promotes hydrophobicity of the monomer and/or polymer.

The industry-preferred hydrophobic material PTFE may not be considered as a preferred candidate for the curable composition. PTFE is inherently difficult to solvate and furthermore, no industry has been able to functionalize or utilize PTFE as a stand-alone resin. PTFE molecules have not been shown to photocure nor has anyone displayed use in a phase separated foam. PTFE is limited as a product because the use of PTFE requires wrapping the PTFE material around structures, and thus is typically limited for use as an additive, a coating, a wrapping, or a filler. PTFE cannot saturate, infill, impregnate, etc. a structure.

In some approaches, an amount of monomer in the curable composition may be in a range of 15 wt. % to 50 wt. % of a total weight of the curable composition. A loading of monomer higher than 50 wt. % of the curable composition may result in a brittle material, and alternatively a loading of monomer below 15 wt. % may result in a weak mixture that tears easily, e.g., a material that is not structurally sound.

In various approaches, a curable composition include a porogen for forming nanopores in the cured polymeric material. Preferably, the porogen forms a homogenous population of nanopores in the polymeric material, e.g., intra-material pores. In an exemplary approach, the porogen forms a homogenous population of nanopores in a hydrophobic polymeric material. The intra-material nanopores preferably have an average maximum diameter in a range of about 100 nm to 500 nm. A range of nanopores may be derived from a resin having higher wt. % of monomers; and a range of larger pores, e.g., micropores, may be derived from a resin having lower wt. % of monomers.

The porogen preferably interacts with, but does not chemically react with, the solvent as well as the hydrophobic material. A preferred porogen includes molecules that do not react with the components of the curable composition. For example, the porogen may include TEG, polyethylene glycol (PEG), etc.

According to one inventive aspect, a porogen is present in the curable composition in an effective amount to cause phase separation during crosslinking of the hydrophobic monomer. The effective amount of porogen may be determined according to the monomer, solvent, and porogen present in the curable composition. In preferred approaches, the curable composition includes an amount of porogen in a range of about 10 wt. % to about 50 wt. % of a total weight of the curable composition In some approaches, the curable composition includes an amount of porogen in a range of 18 wt. % to about 35 wt. %. An exemplary approach includes about 27 wt. % porogen in the curable composition. An amount of porogen above 50 wt. % may cause the resin in the system described herein to phase separate before crosslinking, thereby resulting in the inability to control phase separation during crosslinking.

According to one inventive aspect, the solvent may be selected to solvate the monomer present in the curable composition. In preferred approaches, the solvent may be selected to solvate the hydrophobic monomer present in the curable composition. In one approach, the solvent may be a nonpolar solvent that dissolves a selected monomer. In one approach, the monomer may be dissolved in the solvent. In another approach, the monomer may be dispersed in the solvent. In some approaches, a dispersed monomer in a solvent may encompass phase separation of the solvents. In another approach, the solvent may be a polar solvent that dissolves another selected monomer. The solvent may also solvate the porogen, but preferably, the solvent does not solvate the porogen very well. The solvent may be a nonpolar or a polar solvent. In preferred approaches, the curable composition includes a solvent that in the absence of crosslinking properly suspends the resin components and then induces phase separation during crosslinking of the hydrophobic material. In various approaches, a preferred solvent is a polar solvent that does not solvate the porogen well. Moreover, a preferred solvent is a polar solvent that is capable of swelling the hydrophobic monomer.

In one example, the solvent is a polar solvent such as N-methylpyrrolidone (NMP). A curable composition having a higher percentage of a porogen such as functionalized triethylene glycol (TEG) causes a polar solvent such as NMP to induce phase separation during crosslinking of the hydrophobic monomer. In various approaches, a polar solvent may include NMP, methanol, ethanol, isopropanol, butanol, glycerol, acetone, methyl ethyl ketone, formaldehyde, acetaldehyde, acetic acid, propionic acid, formic acid, ethyl acetate, butyl acetate, acetonitrile, DMSO, water, etc.

In some approaches, a percentage of solvent added to the resin mixture matches the weight loading of the monomer. In a preferred approach, an amount of the solvent is about equal to the amount of monomer by weight. In one approach, an amount of solvent may be present in a range of about 5% of the amount of monomer. In another approach, an amount of solvent may be present in arrange of about 15% of the amount of monomer. For example, a higher weight loading of the monomer in the resin may correlate with higher weight loading of the solvent, or alternatively, less monomer in the resin may correlate with less solvent included in the resin. According to one inventive aspect, a resin for impregnating a conductive metal structure includes at least three components: a solvent, a porogen, and a hydrophobic material. In one example, the resin, or curable composition, includes the solvent NMP, the porogen TEG, and the hydrophobic material PFPE.

In one example, an exemplary ratio of these components is 35 wt. % PFPE and 40 wt. % solvent, and 25 wt. % porogen. Shifting the different percentages of the components can make the material more porous or less porous, more flexible or less flexible, more hydrophobic or less hydrophobic, etc. The hydrophobic material is tunable according to the application of the electrode having the hydrophobic material.

In various approaches, the curable composition includes a curing agent. Preferably, the curing agent is a photoinitiator (e.g., a photochemical crosslinker), such as a radical initiator crosslinker. In various approaches, the photoinitiator may be a radical initiator that is active in the UV region. For example, a photoinitiator may include aryl ketones such as acetophenone and benzoin, aminoketones such as Irgacure 651, benzyl compounds such as benzyl benzoate, thioxanthones such as isothioxanthone, cationic photoinitiators such as 2-Hydroxy-2-methylpropiophenone or TPO-L, hydroxyalkylphenones such as Irgacure 1173, Norrish type 1 and type 2 photoinitiators, camphorquinone, eosin Y, etc. In some approaches, the curing agent is a thermal initiator such as BPO. In one approach, the resin may include a photoinitiator and a thermal initiator. In some approaches, the curing agent may be a cationic initiator or an anionic initiator.

Referring back to FIG. 3, operation 304 includes infilling the conductive metal structure with the resin. According to one approach, resin may be poured over a mechanical structure so that the mechanical structure is saturated with the resin. Then the resin is photocured while saturated in the mechanical structure. The curing may be a crosslinking process by UV light. The curing process may also include thermal curing using added heat. In one example, exposure of a hydrophobic resin to UV light causes a crosslinking of the hydrophobic resin into position and forces phase separation of the hydrophobic resin. Curing of the hydrophobic monomer increases the effective concentration of porogen in solution which causes further phase separation of the hydrophobic monomer and porogen, forming pores in the hydrophobic material and yielding a porous structure.

As described herein, the metal structure provides voids, pores, etc. that are infilled with the resin, and allows access of the resin to applied UV light. Moreover, the penetration depth of the membranes, metal structure, etc. with the resin may be in a range of 50 μm to 10,000 μm microns.

In one approach, an infill process includes a layer of resin on a substrate (e.g., a glass slide), then the metal structure is layered onto the layer of resin, e.g., a resin pool, and the resin seeps into the voids of the metal structure. Another layer of resin is added on top of the metal structure, allowing the resin to seep from the top down into the voids of the metal structure. A second glass slide is lowered diagonally onto the top of the resin+metal structure, in order to prevent air bubbles in the composite.

Referring now to FIG. 4, part (b), in one exemplary example, the electrically conductive metal structure 402 is saturated with hydrophobic resin 408, e.g., curable composition, such that the ligaments 410 are now coated with the hydrophobic resin 408. The pores 406 defined by the ligaments 404 are filled with hydrophobic resin 408. The composite 412 includes a conductive metal structure 402 impregnated with hydrophobic resin 408. The mechanical structure impregnated with hydrophobic material allows through-plane electrical conductivity in the structure and prevents the presence of water within the structure.

Referring to FIG. 3, operation 306 includes curing the resin to form an electrically conductive and polymeric composite having the electrically conductive metal structure impregnated with the cured resin. The resin, e.g., curable composition, may be exposed to UV light to initiate curing of the resin. In another approach, the resin may be heated in an oven at 70° C. for duration of time (e.g., 10 minutes) in the presence of a thermal initiator to cure the composition to completion. In one approach the curing may include exposing the composite of the conductive metal structure impregnated with the resin, e.g., curable composition, to UV light and then to heat for curing using both a photoinitiator and a thermal initiator.

In various approaches, once the resin and the metal structure are positioned between the two glass slides, the crosslinking of the resin is allowed to occur. Preferably, the crosslinking means (e.g., UV light, heat, etc.) is not applied until the second glass slide is placed on the composite of resin+metal structure. If the crosslinking means are applied before the glass slide is added to the composite, and the resin is open to the air, the air may introduce oxygenated additions and the functional groups may be inhibited from crosslinking. Sandwiching the resin+metal structure between two glass slides enables crosslinking and better penetration depth of crosslinking. Sufficient time allows the resin to wick into the foam by capillary action, and thereby crosslink without introduction of air bubbles, oxygenation, etc. After crosslinking, the crosslinked composite with glass slides is loaded into a chamber, and further crosslinked for 60 seconds.

Operation 308 includes drying the electrically conductive and polymeric composite to form the permeable electrically conductive electrode. Preferably, the drying technique removes the solvent and porogen from the pores of the hydrophobic composite without collapsing the pores. In an exemplary approach, the method includes drying an electrically conductive hydrophobic composite to form a permeable, electrically conductive, and hydrophobic electrode.

In some approaches, the drying of the cured composite may include supercritical drying so that gas is present in the pores formed by the porogen. For supercritical drying, a solvent is used in the drying steps for removing the porogen. The solvent is preferably a solvent that solvates the porogen so that the porogen may be removed during the drying steps. In conventional supercritical drying methods, the solvent is typically ethanol, isopropanol, methanol, etc. Acetone is typically not used as a solvent during supercritical drying. In the described method herein, however, acetone is the preferred solvent because acetone solvates porogens such as TEG, and will promote complete removal of the TEG from the structure. In addition, the solvent for the supercritical drying step preferably solvates the solvent included in the curable composition, such as the solvent NMP. The solvent for the supercritical drying needs to solvate the porogen and the solvent of the resin. In an exemplary approach, acetone is a preferred candidate solvent for the super critical drying process.

In another approach, the drying of the cured composite may include freeze drying to remove the solvent and porogen from the pores without collapsing the pores formed by the porogen. Freeze drying can function with a number of solvents, generally with higher vapor pressures and functions under the basic principle of sublimation to remove solvent directly from the solid phase.

According to one inventive aspect, method 300 may include an additional operation of depositing a layer of catalyst onto a surface of the permeable electrically conductive electrode. In an exemplary approach, the method includes depositing a layer of catalyst onto a surface of a permeable, electrically conductive and hydrophobic electrode. The catalyst may be deposited onto the permeable, electrically conductive and hydrophobic composite by electrodeposition, electron beam (EBEAM), electroless deposition, atomic layer deposition, cathodic arc, magnetron sputtering, pulsed laser deposition, thermal evaporation, chemical vapor deposition, etc. In one example, a layer of copper is sputtered onto the surface of the composite. A catalyst layer, e.g., a layer copper on the surface of the electrode, may have a thickness in a range of 500 nm to 5 microns. The sputtered layer is a uniform layer of copper along the surface of the electrode from one end to the opposite end of the surface.

### EXPERIMENTS

### Hydrophobic Material

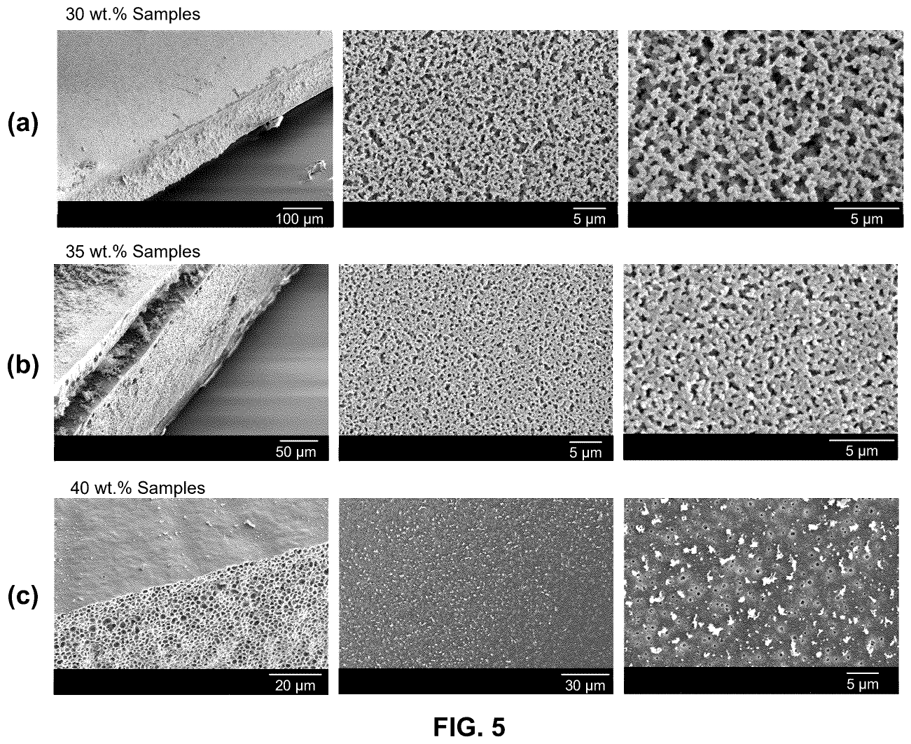

FIG. 5 depicts scanning electron microscope (SEM) images of hydrophobic material PFPE at varying monomer loading. Part (a) 30 wt. % PFPE, part (b) 35 wt. % PFPE, and part (c) 40 wt. % PFPE.

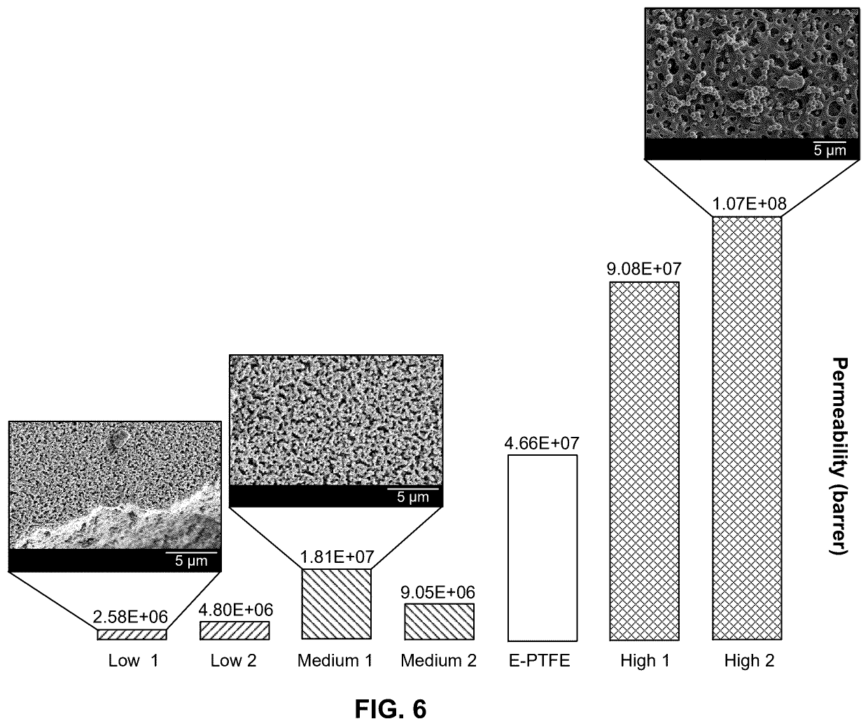

FIG. 6 illustrates the difference in permeability with varying light intensity used for the photocuring of curable solution compositions having 35 wt. % of PFPE. Permeability was measured using CO₂ flow through the material where upstream pressure was compared to downstream pressure in terms of barrer units (1 barrer=1⁻¹⁰ [(cm³_{STP}·cm)/cm²·s·cmHg)]. Low UV light intensity indicates irradiation with 0.6 mW/cm², medium UV light intensity indicates irradiation with 2.5 mW/cm², and high UV light intensity indicates irradiation with 8 mW/cm². Each measurement was tested on two samples (1 and 2). Increased light intensity significantly increased the permeability of the compositions. As a control, E-PTFE was mechanically expanded to a certain pore-size.

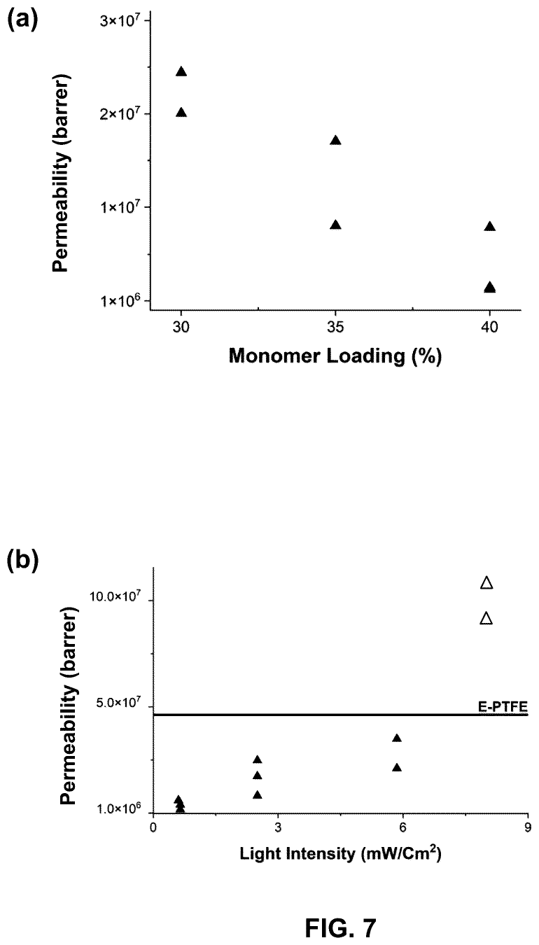

FIG. 7 illustrates control of permeability of hydrophobic material. Part (a) is a plot of monomer loadings versus permeability of PFPE material. The permeability decreases with increased loadings of the monomer. Part (b) is a plot of light intensity used for photocuring of the PFPE material versus permeability of the 35 wt. % samples. Altering one of the curing conditions, such as increased light intensity, correlates to increased permeability of the PFPE material. The open triangles highlight the high permeability that can be achieved compared to commercially purchased E-PTFE (black line). The methodology described allows control of permeability using monomer loadings and light intensity.

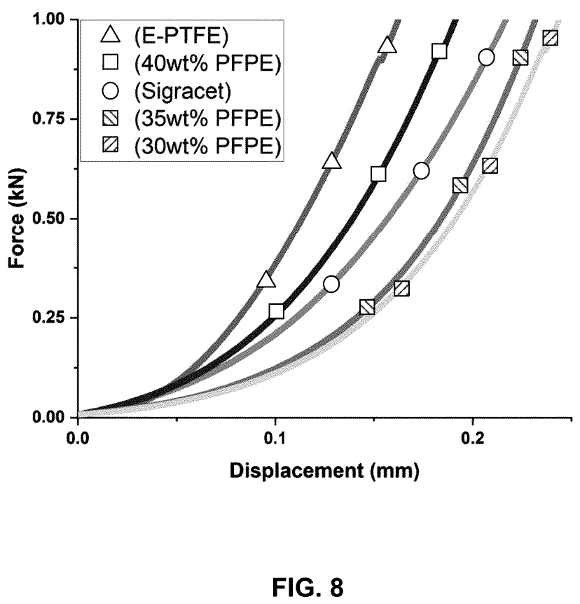

FIG. 8 is a plot of force versus displacement of different hydrophobic materials. Different loadings of PFPE (30 wt. %, 35 wt. %, and 40 wt. %) for comparison with commercially available carbon gas diffusion media (Sigracet™, SGL Carbon, Charlotte, NC) and E-PTFE. The plot shows the modulus (i.e., stiffness) of the material in a force versus displacement diagram. As illustrated, PFPE material may reach similar modulus to that of PTFE at maximum loading (40 wt. %) and can also be tuned to a lower loading (30 wt. %) to have a modulus lower than that of carbon paper (Sigracet).

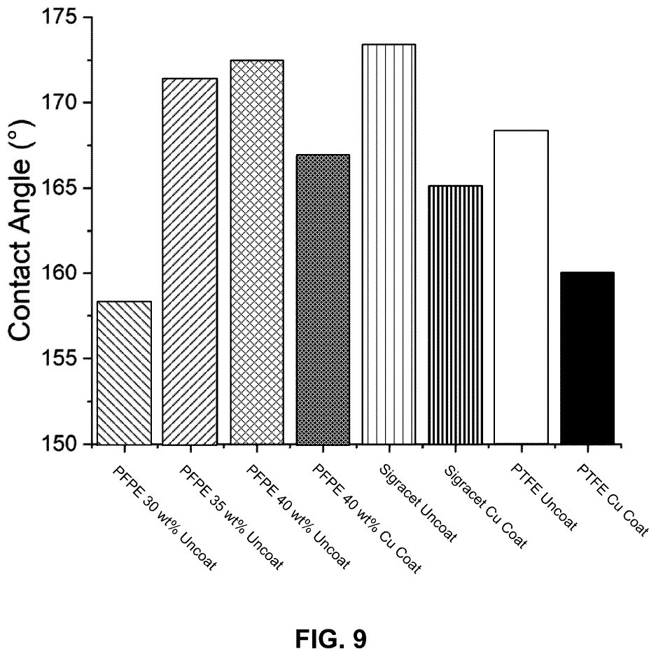

FIG. 9 illustrates relative contact angle of hydrophobic materials. The surface chemistry of the hydrophobic material was tested by determining the contact angle of the materials to determine a degree of hydrophobicity of the respective material. As known in the art, a contact angle greater than 90° may indicate the surface is hydrophobic. All samples have a contact angle greater than 90°, and thus are considered hydrophobic. Moreover, all samples have a contact angle greater than 150° and thus are considered super hydrophobic, with higher loadings of PFPE (35 wt. % and 40 wt. % demonstrating high contact angles above 170°. Addition of a Cu coating reduced the contact angle of the samples, however, the samples remained super hydrophobic.

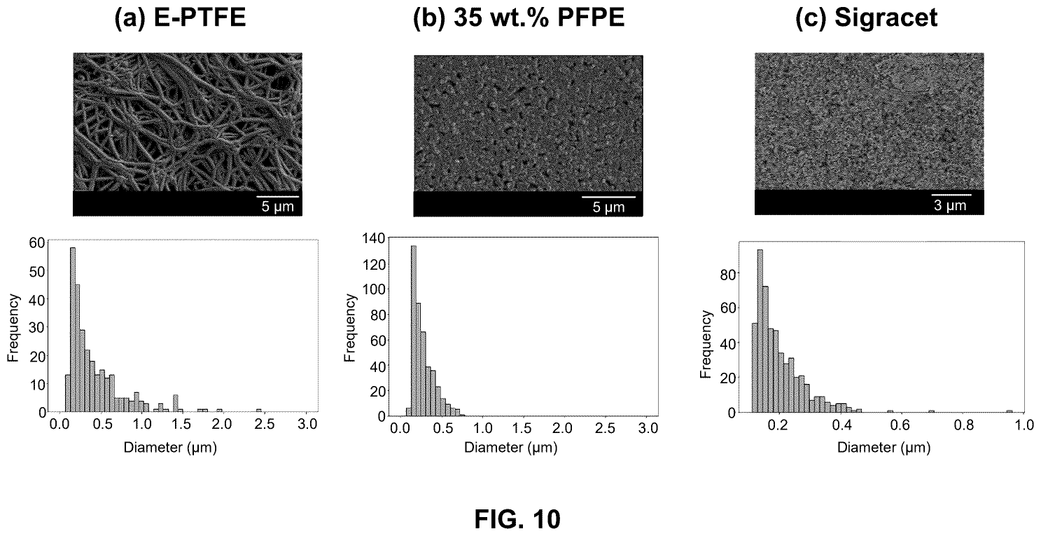

FIG. 10 illustrates the relative intra-material pore size of different hydrophobic materials. The upper figures of each part is an SEM image of the hydrophobic material, and the lower figure is a plot of the pore distribution of the region depicted in the image. Part (a) depicts commercially available expanded PTFE (E-PTFE), part (b) depicts 35 wt. % PFPE, and part (c) depicts commercially available Sigracet (carbon). 35 wt. % PFPE material achieves pores having similar size-scale as E-PTFE and Sigracet™ with an improved pore-size distribution.

### Electrochemical Cell for Testing Hydrophobic Material

A single-gap electrochemical cell for testing the electrodes included a 3D printed electrode backing that provided greater control over GDE interface. Custom electrode backing was used to mount all of the electrodes tested. The 3D printed electrode backing allowed control of the interface between the GDE and the flow gas as well as reducing the gap between the cathode and the membrane. The total geometric area of the electrode was about 1.2 cm², smaller than typical electrochemical cells, and offered enhanced charge uniformity. 1 M and 0.1 M potassium bicarbonate (KHCO₃) were selected anolyte solutions, and were swapped after 1 hour running at each current density.

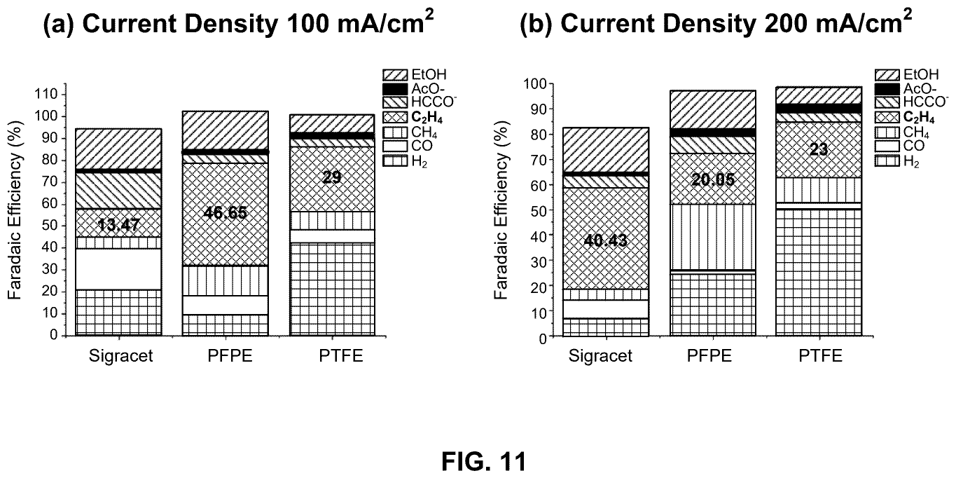

FIG. 11 depicts products formed in a single gap electrochemical cell having selected electrodes that include the following hydrophobic material: 1 M Sigracet™, 1 M PFPE, and 1 M PTFE. The products of the reaction in the cell have been quantified in the bar graph to show the product distribution in a 1 M anolyte concentration, potassium bicarbonate (KHCO₃) at a current density of 100 mA/cm² (part (a)) and 200 mA/cm² (part (b)).

As illustrated in part (a), the PFPE material in a single gap custom 3-D print electolyzer demonstrated good selectivity towards ethylene at specific current densities (100 mA/cm²). Moreover, PFPE had higher selectivity towards “C₂+” products (e.g., C₂H₂) than either of the commercially available materials at 100 mA/cm².

However, as illustrated in part (b), the PFPE material did not demonstrate similar product distribution at the higher current density of 200 mA/cm².

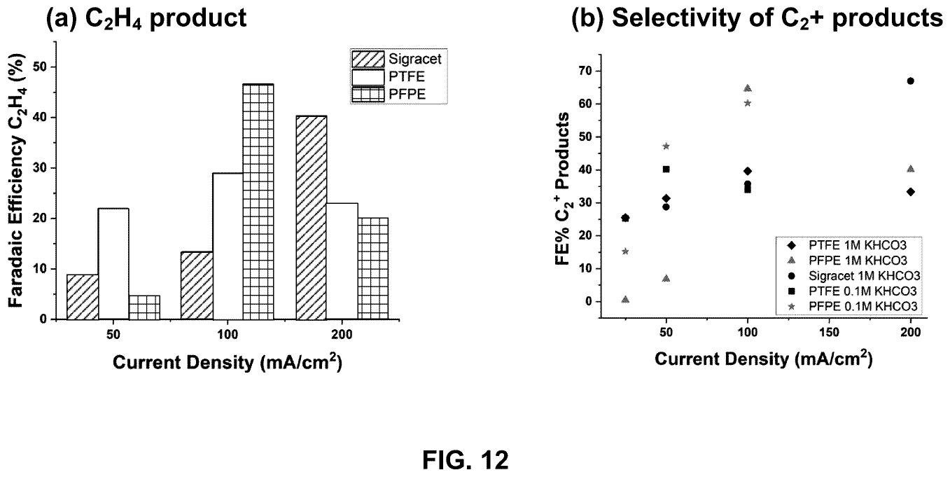

FIG. 12 depicts plots of selectivity of C₂+ products at different current densities. Part (a) depicts the faradaic efficiency (%) of C₂H₄ products. The preferred PFPE material demonstrated higher faradaic efficiency of C₂H₄ products at the current density of 100 mA/cm² compared to the commercially available materials Sigracet™ and PTFE. Part (b) depicts a plot of the selectivity of C₂+ products. The PFPE systems (▴ with 1 M KHCO₃, and «with 0.1 M KHCO₃) demonstrated the highest selectivity for C₂+ products at a current density of 100 mA/cm².

Electrochemical Cell with Electrode Having Metal Conductive Structure and Hydrophobic Material

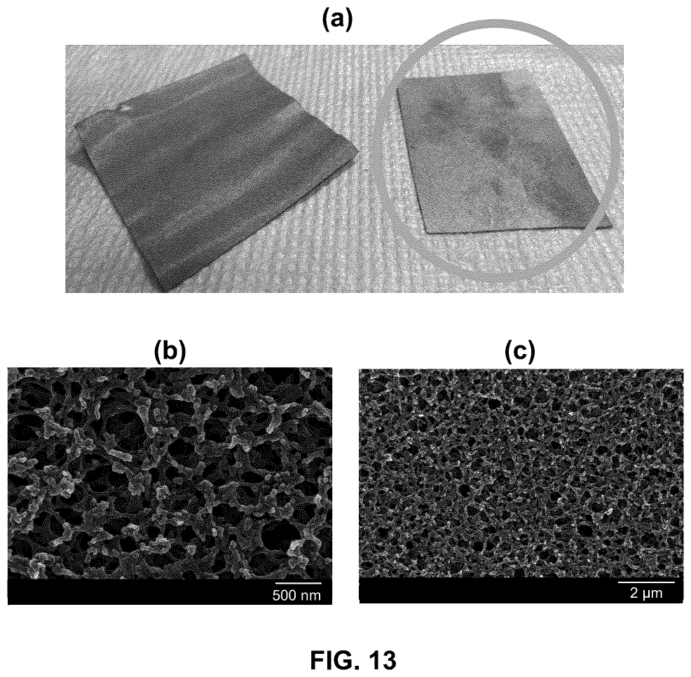

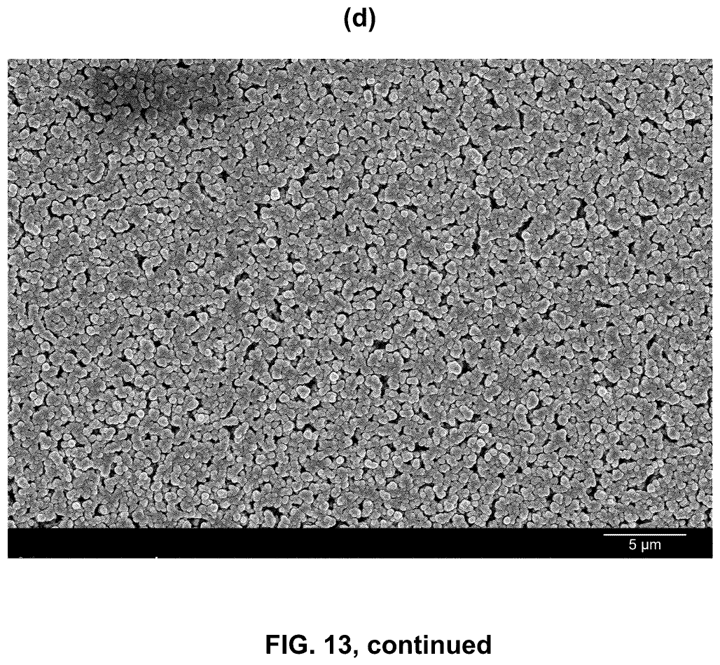

An electrode, according to one aspect described herein, was formed with a copper (Cu) metal structure infilled with PFPE hydrophobic material as depicted in FIG. 13. Part (a) is an image of the. The Cu structure on the left is the material as received from the manufacturer. The material does not have a uniform flattened structure and would not be a good candidate for impregnating with PFPE resin. The circled structure on the right side of the image is a hot-pressed conductive Cu metal structure that has been flattened into a uniform structure, more dimensionally uniform, and ready for infilling with PFPE resin.

Parts (b) and (c) of FIG. 13 are SEM images of the surface of the Cu metal structure impregnated with 35 wt. % PFPE resin, displaying uniform porosity and morphology over three varying length scales. Part (d) displays the same sample after coating with 500 nm of copper catalyst, which decreases the average pore size but clearly retains porosity and permeability of the sample.

The zero-gap electrochemical cell having an anode and a cathode where one of the electrodes, e.g., the cathode, includes a hydrophobic resin infilled in a conductive metal structure allowing a direct connection and plane connectivity between the cathode into the membrane into the anode, forming a sandwich of materials has a maximum amount of pressure up to about 110 psi, and in a range of 80 to 110 psi.

Metal current collectors are bolted sections of the cells and make contact directly with the anode and the cathode. Assessment of the copper film is compressed with the resin infilled in the copper film have been compared to commercially available carbon paper typically used for conductivity. The resistance between the two current collector plates was compared, the anode and cathode are electrically contacting the membrane in the center of the cell. The resistance was measured between the anode and cathode with both materials comparatively compressed at the same compression between the current collectors (e.g., mimicking how the cell would be operating). The resistance measured 0.1Ω for the copper resin composite compared to 0.9Ω for the carbon paper. There was almost a 10-fold difference in resistance.

In one approach, a potentiostat data point from the electrolyzer testing stand indicated the cell voltage was stable and low. Using back contact in a zero-gap cell provides less resistance than that of a carbon GDE.

### Through-Plane Conductivity

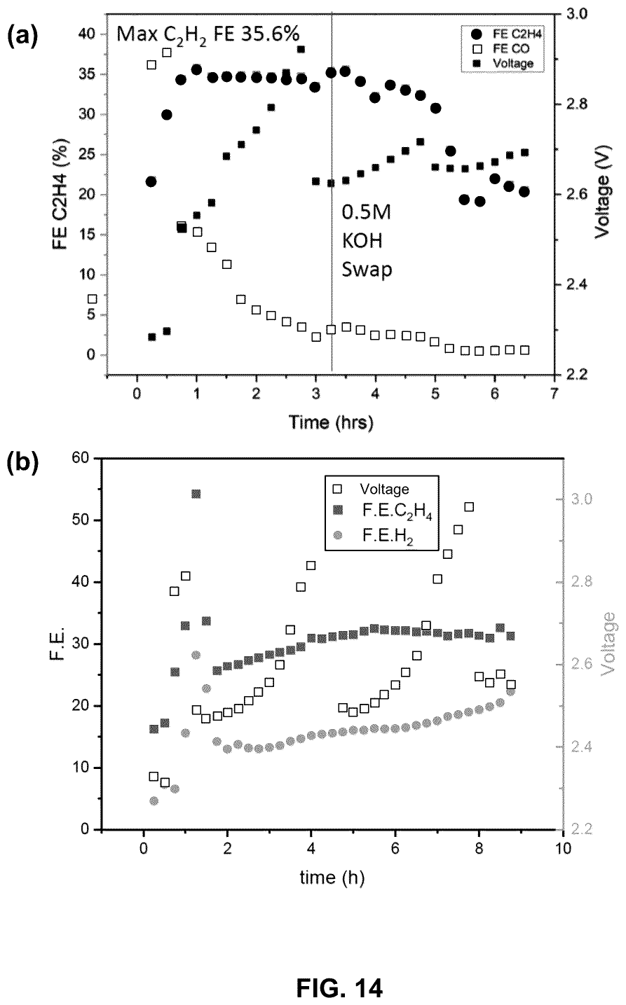

FIG. 14 illustrates through-plane conductivity using the electrode having hydrophobic material as described herein. The electrode having a conductive metal structure impregnated with hydrophobic resin functions as a front contact and/or back contact. Part (a) is a plot that depicts “front contact” that is achieved via a copper coated gasket and does not require through plane conductivity. Part (b) depicts a plot of “back contact” that is achieved via through plane conductivity of the copper-hydrophobic resin composite electrode.

Part (a) includes faradaic efficiency (FE) of ethylene (CO₂ to C₂H₄)(●) and faradaic efficiency (FE) carbon monoxide (CO₂ to CO)(□) over time. Voltage (n) is the operating cell voltage of the electrolyzer. Just after 3 hours of operation, the anolyte is switched from 0.5 M CsOH to 0.5 M KOH. The electrolyzer is run at 40° C. for up to 7 hours. The plot demonstrates that during continuous application of cell voltage, the faradaic efficiency of the product ethylene (C₂H₄) is maintained above 20%. The operation did not salt out with K⁺, which may indicate the composite allows salt/liquid to pass through likely along hydrophilic copper pathway. A decrease in performance after about 4 hours may be related to Cs⁺ depletion.

Part (b) depicts a plot representing back contact values of faradaic efficiency of C₂H₄ product (n) and hydrogen H₂ (●). Voltage (□) is the operating voltage of the electrolyzer as assessed at the back contact. The changes in voltage was due to acidification of anode liquid reservoir. The plot demonstrates that electrode demonstrate through-plane conductivity, and the faradaic efficiency of C₂H₂ and H₂ remains essentially constant during greater than 8 hours of operation.

According to one approach, the hydrophobic resin/metal structure composite may be used in chloralkaline electrolyzers that typically include hydrophobic material.

### In Use

Various aspects of an inventive concept described herein may be used as a cathode in electrochemical cells.

The inventive concepts disclosed herein have been presented by way of example to illustrate the myriad features thereof in a plurality of illustrative scenarios, aspects of an inventive concept, and/or implementations. It should be appreciated that the concepts generally disclosed are to be considered as modular, and may be implemented in any combination, permutation, or synthesis thereof. In addition, any modification, alteration, or equivalent of the presently disclosed features, functions, and concepts that would be appreciated by a person having ordinary skill in the art upon reading the instant descriptions should also be considered within the scope of this disclosure.

While various aspects of an inventive concept have been described above, it should be understood that they have been presented by way of example only, and not limitation. Thus, the breadth and scope of an aspect of an inventive concept of the present invention should not be limited by any of the above-described exemplary aspects of an inventive concept, but should be defined only in accordance with the following claims and their equivalents.

What is claimed is:

1. An electrode, comprising:
a composite comprising:
an electrically conductive metal structure having ligaments and a plurality of pores defined by the ligaments; and
a porous material present in the plurality of pores in the conductive metal structure,
wherein the electrode has through-plane electrical conductivity.

2. The electrode as recited in claim 1, wherein the conductive metal structure includes an electrically conductive metal that is an inert metal.

3. The electrode as recited in claim 1, wherein the conductive metal structure includes a metal selected from the group consisting of: copper, gold, silver, aluminum, tin, bismuth, platinum, palladium, nickel, iridium, titanium, scandium, ruthenium, chromium, cobalt, hafnium, boron, tantalum, tungsten, and vanadium.

4. The electrode as recited in claim 1, wherein the conductive metal structure includes copper.

5. The electrode as recited in claim 1, wherein the ligaments have an average diameter in a range of greater than 0 microns to less than 50 microns, wherein an average maximum diameter of the pores is in a range of greater than 100 microns to less than 1000 microns.

6. The electrode as recited in claim 1, wherein the conductive metal structure has outer dimensions that are about equal to dimensions of the electrode.

7. The electrode as recited in claim 1, wherein the porous material has a plurality of intra-material nanopores, the intra-material nanopores having an average maximum diameter in a range of 100 nanometers to 1000 nanometers.

8. The electrode as recited in claim 1, wherein the electrode is a gas diffusion electrode.

9. The electrode as recited in claim 1, wherein the porous material includes a monomer selected from the group consisting of: perfluoropolyether (PFPE), a siloxane, a polyester, a polypropylene, a poly(lactic-co-glycolic) acid (PLGA), a polyethylene, a polystyrene, a urethane, a thiol-ene, an acrylic, an epoxy, a methyl methacrylate, vinyl chloride, a low-density polyethylene (LDPE), a polyamide, a polyimide, and nylon.

10. The electrode as recited in claim 1, wherein the porous material is a porous hydrophobic material.

11. The electrode as recited in claim 1, further comprising, a layer of a catalyst positioned directly on a surface of the composite.

12. The electrode as recited in claim 11, wherein the catalyst includes at least one catalyst material selected from the group consisting of: gold, silver, tin, bismuth, platinum, palladium, iron, nickel, iridium, titanium, molybdenum, indium, scandium, copper, and a combination thereof.

13. A method for forming a permeable electrically conductive electrode, the method comprising:
obtaining an electrically conductive metal structure;
infilling the conductive metal structure with a resin, the resin comprising: a monomer, a porogen, a curing agent, and a solvent;
curing the resin to form an electrically conductive polymeric composite having the conductive metal structure impregnated with the cured resin; and
drying the electrically conductive polymeric composite to form the permeable electrically conductive electrode.

14. The method as recited in claim 13, wherein the drying includes a drying method selected from the group consisting of: supercritical drying and freeze-drying method, wherein the solvent and the porogen are removed from the composite.

15. The method as recited in claim 13, further comprising, depositing a layer of catalyst onto a surface of the permeable electrically conductive electrode.

16. A curable composition, comprising:
a monomer;
a porogen; and
a solvent, wherein the monomer is solvated in the solvent.

17. The curable composition as recited in claim 16, wherein the monomer is selected from the group consisting of: perfluoropolyether (PFPE), a siloxane, a polyester, a polypropylene, a poly(lactic-co-glycolic) acid (PLGA), a polyethylene, a polystyrene, a urethane, a thiol-ene, an acrylic, an epoxy, methyl methacrylate, vinyl chloride, a low-density polyethylene, a polyamide, a polyimide, and a nylon.

18. The curable composition as recited in claim 16, wherein the monomer has at least one functional group for crosslinking, wherein the at least one functional group is selected from the group consisting of: silane, acrylate, thiol, difunctional acrylate, methacrylate, difunctional methacrylate, diene, vinyl, hydroxyl, carbonyl, carboxyl, amino, sulfhydryl, phosphate, and amidogen.

19. The curable composition as recited in claim 16, wherein the monomer is a hydrophobic monomer.

20. The curable composition as recited in claim 16, wherein an amount of the monomer is in a range of 15 weight % to 50 weight % of a total weight of the curable composition.

21. The curable composition as recited in claim 20, wherein an amount of the solvent is about equal to the amount of the monomer by weight.

22. The curable composition as recited in claim 16, wherein an amount of the porogen is in a range of 10 weight % to 50 weight % of a total weight of the curable composition.

23. The curable composition as recited in claim 16, wherein the curable composition is a liquid.

24. The curable composition as recited in claim 16, further comprising a curing agent selected from the group consisting of: a photoinitiator, a thermal initiator, a cationic initiator, and an anionic initiator.
